(19) United States
(12) Patent Application Publication
(10) Pub. No.: US 2012/0176616 A1
(43) Pub. Date: Jul. 12, 2012

(54) FLUID SUBMERSIBLE SENSING DEVICE

(76) Inventors: Carlton D. Hunt, Bridgewater, MA (US); Derek M. Michelin, Plymouth, MA (US); Michael P. Neal, Powell, OH (US); Christian K. Sieracki, Edgecomb, ME (US); J. Caleb Chitwood, Canal Winchester, OH (US); Douglas B. Pape, Upper Arlington, OH (US); David A. Fingerhuth, Marysville, OH (US)

(21) Appl. No.: 13/379,964

(22) PCT Filed: Jun. 17, 2010
(86) PCT No.: PCT/US10/38940

§ 371 Date: Feb. 15, 2012

Related U.S. Application Data
(60) Provisional application No. 61/220,269, filed on Jun. 25, 2009.
(60) Provisional application No. 61/306,061, filed on Feb. 19, 2010.

(51) Int. Cl. G01N 21/00

(52) U.S. Cl. 356/338

(57) ABSTRACT

A fluid submersible sensing device is provided comprising a fluid-tight housing defining an internal chamber and including window structure; sensing structure provided in the internal chamber; light providing apparatus in the internal chamber emitting light capable of passing through the window structure so as to exit the housing; and a sample-providing structure coupled to the housing and located outside of the housing internal chamber comprising a passage through which a fluid flows. The passage may have a longitudinal axis substantially parallel with a flow path through the passage and a cross sectional area substantially transverse to the longitudinal axis. The light from the housing exits the housing, passes through the sample-providing structure including the passage and re-enters the housing toward the sensing structure.

### TECHNICAL FIELD

The present invention relates to a fluid submersible sensing device and, more particularly, to such a device having sensing structure provided within a fluid-tight housing and an external structure located outside of the fluid-tight housing including a passage through which a fluid sample flows.

### BACKGROUND ART

Flow cytometry is a process for characterization and quantification of microscopic particles suspended in a stream of fluid. A fluid submersible flow cytometer is known comprising a fluid-tight housing having an internal chamber containing a detector, a light source and a flow cell through which a stream of fluid to be analyzed moves. Light from the light source is passed through the stream of fluid and received by the detector for characterization and quantification of the particles within the fluid.

### DISCLOSURE OF INVENTION

In accordance with a first aspect of the present invention, a fluid submersible sensing device is provided comprising: a fluid-tight housing defining an internal chamber and including window structure; sensing structure provided in the internal chamber; light providing apparatus in the internal chamber emitting light capable of passing through the window structure so as to exit the housing; and an external structure coupled to the housing and located outside of the housing internal chamber comprising a passage through which a fluid flows and one or more optical elements for causing the light from the housing to pass through the passage and re-enter the housing toward the sensing structure.

The light providing apparatus may comprise one or more of a laser light source, a UV light source and a backlight source.

The sensing structure may comprise an optical analysis and imaging apparatus.

The external structure may comprise: a primary element comprising the one or more optical elements; and a flow cell defining the passage. The primary element may comprise a prism including the one or more optical elements defined by first and second mirrored surfaces on the prism to reflect the light along a desired path such that the light passes through the flow cell including the passage and then re-enters the housing.

The flow cell may comprise a clear body separate from the primary element.

The passage may have a longitudinal axis substantially parallel with a fluid flow path through the passage and a cross sectional area substantially transverse to the longitudinal axis sized such that generally all fluid flowing through the passage is analyzed by the sensing structure.

The passage cross sectional area preferably substantially matches a field of view and depth of focus of an optical analysis and imaging apparatus defining the sensing structure.

In accordance with a second aspect of the present invention, a fluid submersible sensing device is provided comprising: a fluid-tight housing defining an internal chamber and including window structure; sensing structure provided in the internal chamber; light providing apparatus in the internal chamber emitting light capable of passing through the window structure so as to exit the housing; and a sample-providing structure coupled to the housing and located outside of the housing internal chamber comprising a passage through which a fluid flows. The passage may have a longitudinal axis substantially parallel with a flow path through the passage and a cross sectional area substantially transverse to the longitudinal axis. The light from the housing exits the housing, passes through the sample-providing structure including the passage and re-enters the housing toward the sensing structure. The passage cross sectional area may be sized such that generally all fluid flowing through the passage is analyzed by the sensing structure.

The sample-providing structure may comprise a primary element comprising at least one optical element and a flow cell defining the passage.

The primary element may comprise first and second mirrored surfaces to reflect the light along a desired path such that the light passes through the flow cell and then re-enters the housing.

The flow cell may comprise a clear body separate from the primary element and has the passage extending through it.

The window structure may be formed from a single piece of material.

The device may further include a pressure-compensated second housing having electronic components, the second housing separable from the sample-providing structure such that the flow cell in the sample-providing structure can be serviced without opening the second housing.

The second housing may contain a dielectric fluid and the sample-providing structure may contain water, which may be distilled water.

The device may further a focusing mechanism in the internal chamber of the fluid-tight housing for moving the sensing structure with respect to the passage of the sample providing structure.

### BRIEF DESCRIPTION OF DRAWINGS

FIGS. 1 and 2 are side views of a fluid submersible sensing device constructed in accordance with the present invention;

FIG. 3 is a cross sectional view of the sensing device illustrated in FIGS. 1 and 2;

FIG. 4 is a cross sectional view illustrating an external optics and sample providing structure coupled to a first housing of the sensing device;

FIGS. 5 and 6 are perspective views of the external optics and sample providing structure coupled to the first housing;

FIG. 7 is a perspective view of second and third housings of the sensing device illustrated in FIGS. 1 and 2;

FIG. 8 is a cross sectional view of an inlet screen assembly;

FIG. 9 is a side view of a portion of a fluid submersible sensing device including a focusing mechanism constructed in accordance with the present invention;

FIG. 10 is a front view of the portion of the fluid submersible sensing device illustrated in FIG. 9;

FIG. 11 is a top view of the portion of the fluid submersible sensing device illustrated in FIG. 9;

FIG. 12 is a cross sectional view of the sensing device including the focusing mechanism illustrated in FIG. 9; and

FIG. 13 is a cross sectional view illustrating an external optics and sample providing structure coupled to a first housing of the sensing device illustrated in FIG. 12.

### BEST MODE FOR CARRYING OUT THE INVENTION

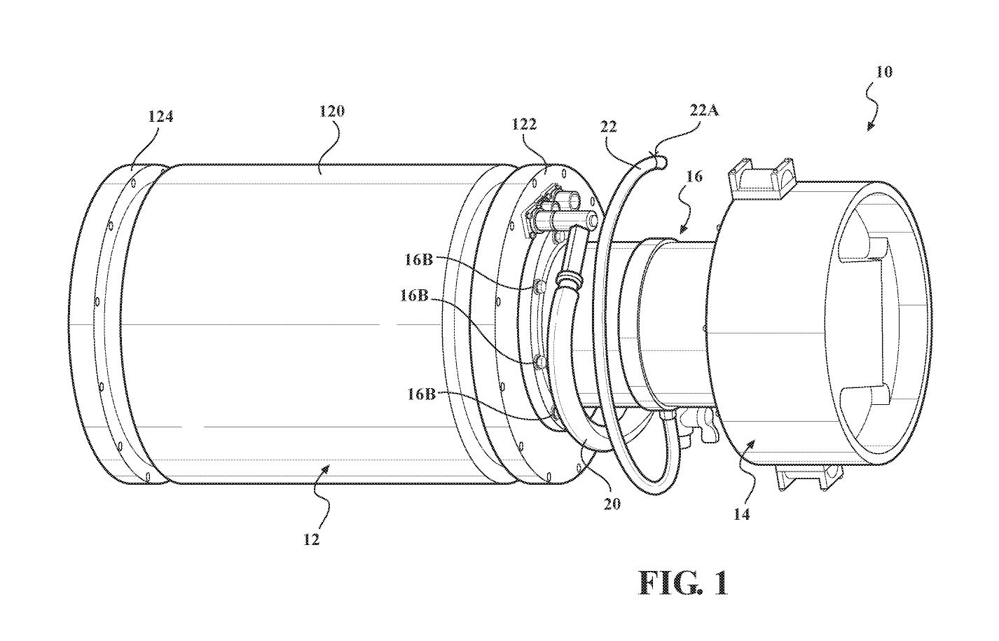

A fluid submersible sensing device 10, constructed in accordance with the present invention, is illustrated in FIGS. 1-3. The device 10 is intended to be used underwater, such as in an ocean, to effect a flow cytometry process for characterization and quantification of microscopic particles suspended in a stream of fluid passing through the device 10.

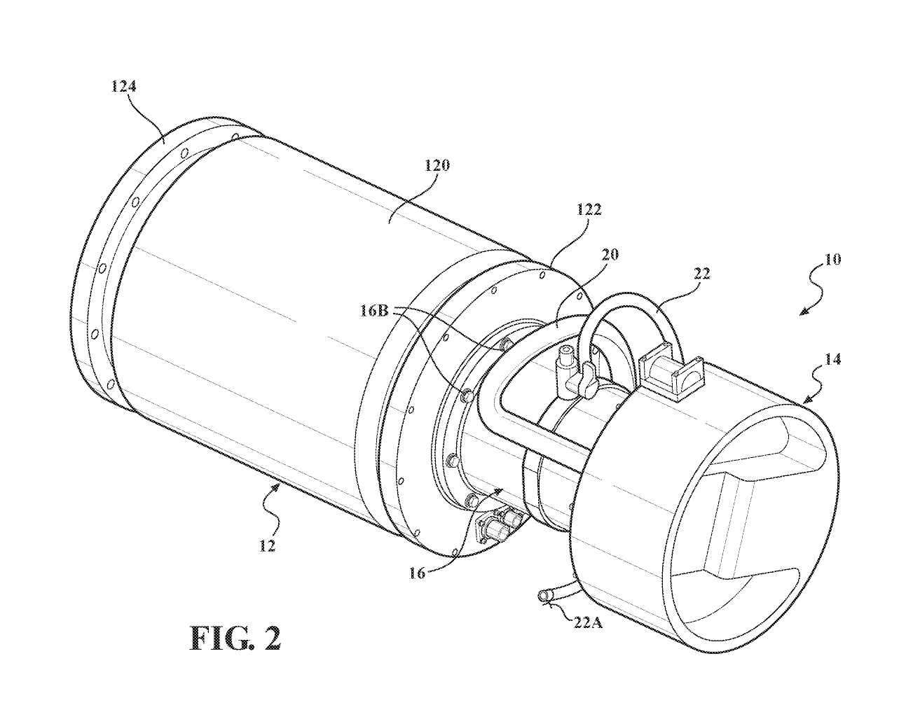

The sensing device 10 comprises a first fluid-tight housing 12 having an internal chamber 12A filled with air, a pressure-compensated second housing 14 having an internal chamber 14A that is preferably filled with a dielectric fluid, e.g., an oil, such as hydraulic or mineral oil, and a pressure-compensated third housing 16 having an internal chamber 16A filled with a liquid having a refractive index (e.g., water having a refractive index=1.333) that approximately matches the refractive index of glass (borosilicate glass having a refractive index=1.515), see FIG. 3. The second housing 14 is coupled to the third housing 16 via bolts 14B, see FIG. 3, and the third housing 16 is coupled to the first housing 12 via bolts 16B, see FIGS. 1-3. The first housing 12 is sealed relative to the second and third housings 14 and 16.

As noted, the internal chamber 14A of the second housing 14 preferably contains a dielectric fluid since the internal chamber 14A of the second housing 14 contains electronic components, which could be damaged if a fluid other than a dielectric fluid is used, e.g., circuits of the electronic components could be shorted if a conducting fluid were used. Further, the internal chamber 16A of the third housing 16 preferably contains distilled water, rather than, for example, oil, since oils fluoresce, which could otherwise interfere with measurements taken by a sensing apparatus 30, as will be discussed in detail herein. The chamber 16A preferably contains distilled water because distilled water approximately matches the optical index of glass, it does not fluoresce, and it inhibits biological/microorganism growth. It is noted that regular (undistilled) water meets the first two of these provisions, but may not inhibit biological/microorganism growth. However, inhibiting biological/microorganism growth may be accomplished via other methods, such as, for example, by adding bleach, alcohol or other biocide to the regular water. Other mechanisms, for example, adding a solid substrate containing a biocide to the regular water, autoclaving the regular water, or coating the internal surfaces of the chamber 16A with copper could also inhibit biological/microorganism growth without adding a liquid biocide to the regular water. Yet a further method for inhibiting biological/microorganism growth with regular water would be irradiating the water with UV or other light to disinfect the water.

It is noted that it is preferable to keep the chambers 14A and 16A separate from one another. This is preferable, for example, as the electronic components in the internal chamber 14A of the second housing 14 may shed wear materials, which wear materials could otherwise interfere with measurements taken by the sensing apparatus 30. Alternatively, if the chambers 14A and 16A are not kept separate, some type of filtering device (not shown) would preferably be used to keep the wear materials out of the internal chamber 16A of the third housing 16.

In the illustrated embodiment, the first housing 12 is constructed from materials having sufficient strength and is sealed such that the pressure within the first housing 12 remains at approximately 1 atmosphere when the device 10 is submerged in water and is dropped to a depth, for example, of about 200 meters. A first tube 20 is coupled to and extends between the first and second housings 12 and 14 and contains electrical wiring (not shown) extending between and coupled to the first housing 12 and the second housing 14. The first tube 20 is in fluid communication with the second housing internal chamber 14A and contains oil. The first tube 20 is sealed at the end adjacent the first housing 12 such that oil is not permitted to exit the first tube 20 and enter the first housing internal chamber 12A. However, the wiring extending through the first tube 20 does exit the first tube 20 and enter the first housing internal chamber 12A. A second tube 22 is coupled to and extends from the third housing 16. The second tube 22 is sealed at its end opposite the end coupled to the third housing 16 via a clip 22A or other sealing structure. The first and second tubes 20 and 22 are exposed to the surrounding water in which the sensing device 10 is submerged. As the sensing device 10 moves deeper into the water, the pressure of the surrounding water increases. The increased pressure of the surrounding water compresses the first and second tubes 20 and 22 so as to vary the pressure of the oil in the second housing internal chamber 14A and the distilled water in the third housing internal chamber 16A such that the pressure of the oil in the second housing internal chamber 14A and the pressure of the water in the third housing internal chamber 16A substantially equals the pressure of the water surrounding the sensing device 10.

The first housing 12 comprises a generally cylindrical first structure 120 and first and second end caps 122 and 124, respectively, all of which may be made from a metal, such as a 6061-T6 Al alloy, see FIG. 3. The first structure 120, the first end cap 122 and the second end cap 124 are bolted and O-ring sealed or otherwise coupled together to create the sealed inner chamber 12A.

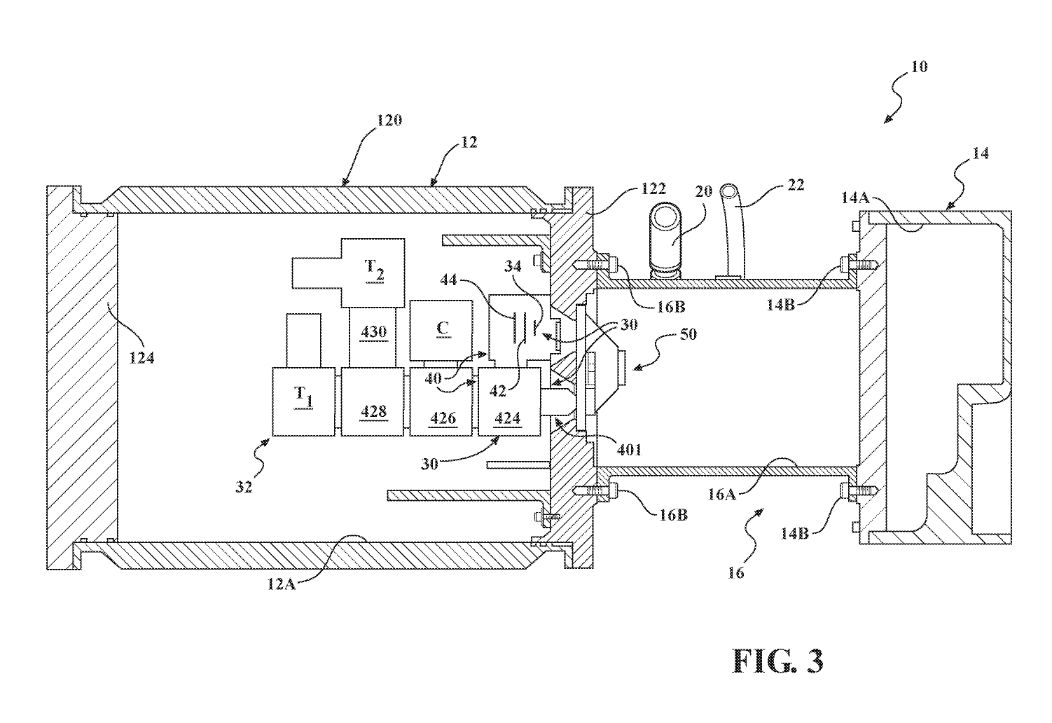

The first end cap 122 is provided with first and second openings 122A and 222A and an adjacent recess 122B surrounding the openings 122A and 222A, see FIG. 4. A window 124A (also referred to herein as “window structure”), formed from clear glass or polymeric material in the illustrated embodiment, is provided in the recess 122B and covers the openings 122A and 222A. The window 124A is coupled to the first end cap 122 via a support plate 126 and bolts 126A, see FIG. 4. It is noted that the window 124A preferably comprises a single piece of glass, plastic, or other suitable material.

The first housing internal chamber 12A contains the sensing structure 30 comprising an optical analysis and imaging apparatus 32, a forward scatter sensor 34, an objective or lens 401, one or more excitation filters 424, a partial mirror 426, one or more fluorescence emission filters 428, and the spacer structure 430, see FIG. 3. The optical analysis and imaging apparatus 32 may comprise a conventional camera C and first and second conventional photo-multiplier tubes T₁ and T₂, see FIG. 3, although it is noted that more photo-multiplier tubes may be used if desired. The first housing internal chamber 12A further comprises light-providing apparatus 40 comprising an LED backlight 42 and a laser light source 44, see FIG. 3, contained within the optical analysis and imaging apparatus 32. An ultra-violet light source (not shown) may also be provided in the first housing internal chamber 12A. The first housing internal chamber 12A further comprises electronics such as processor apparatus (not shown) for controlling the operation of the sensing structure 30 and the light-providing apparatus 40, see FIG. 3. It is contemplated that the optical analysis and imaging apparatus 32 may comprise the structure set out in U.S. Pat. No. 6,115,119, entitled Device and Method for Studying Particles in a Fluid, by Sieracki et al., the entire disclosure of which is incorporated by reference herein.

An external optics and sample providing structure 50 is coupled to the first housing 12 and located outside of the first housing internal chamber 12A so as not to directly communicate with the first housing internal chamber 12A, see FIGS. 4-6. In the illustrated embodiment, the structure 50 is contained within the third housing internal chamber 16A.

The structure 50 comprises a prism 52 and a flow cell 54, both of which are mounted adjacent the window 124A via a strap 56 bolted to the first end cap 122 via bolts 56A, see FIGS. 4-6. The prism 52 is formed from glass or a polymeric material and may have first and second mirrored surfaces 52A and 52B (the mirrors are also referred to herein as “optical elements”), see FIG. 4. In the illustrated embodiment, the mirrored surfaces 52A and 52B may be defined by metal layers, which layers are coated with an epoxy to protect the mirror surfaces 52A and 52B from oxidation. The flow cell 54 may be formed from a clear glass or polymeric material and has a passage 54A through which water to be analyzed passes, see FIG. 4. Because the flow cell 54 is located outside of the first housing internal chamber 12A, risk of water leaking from the flow cell 54 and contacting the electronics and the like within the internal chamber 12A is minimized. As noted above, the window 124A preferably comprises a single piece of material. Forming the window 124A from a single piece of material provides for an optimal amount of optical contact between the window 124A and both the flow cell 54 and the prism 52. It is noted that achieving optical contact between the window 124A and both the flow cell 54 and the prism 52 may be difficult if the window 124A is formed from two separate pieces, as each piece would obtain its orientation from the aluminum end cap 122, which cannot be easily machined to optical tolerances.

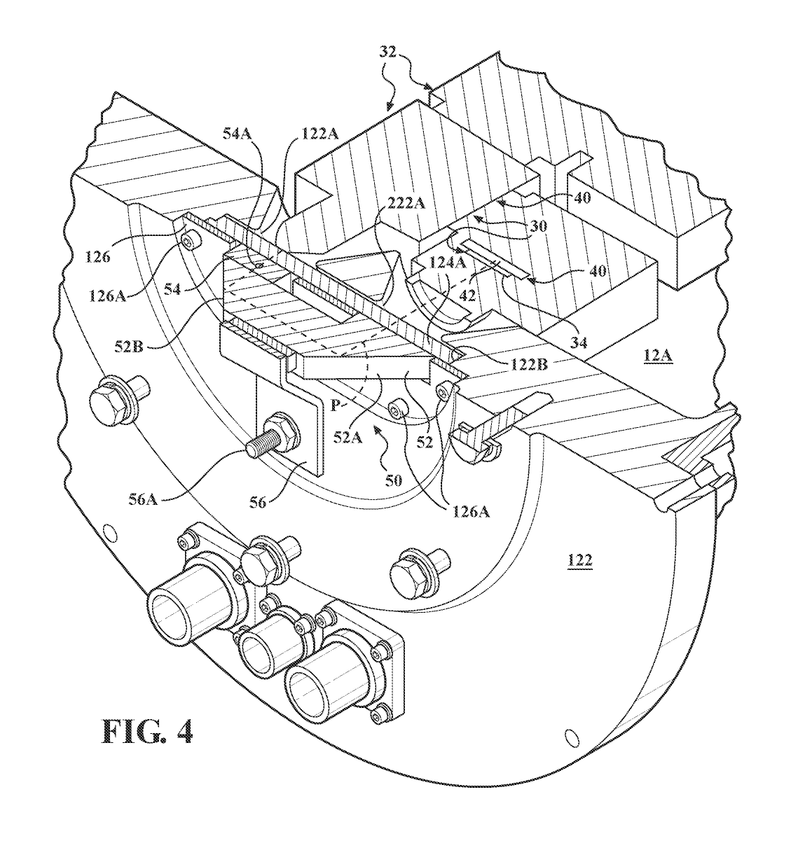

The flow cell passage 54A comprises an inlet 250 and an outlet 252, see FIGS. 5 and 6. A first end 260A of a first conduit 260 is coupled to the passage inlet 250 via a fitting (not shown), friction fit or the like, while the second end (not shown) of the first conduit 260 is coupled within the third housing internal chamber 16A to a first side of an inlet fitting 160 coupled to the third housing 16. A first end 262A of a second conduit 262 is coupled to the passage outlet 252 via a fitting (not shown), friction fit or the like, while a second end (not shown) of the second conduit 262 is coupled within the third housing internal chamber 16A to a first side of an outlet fitting 162 coupled to the third housing 16.

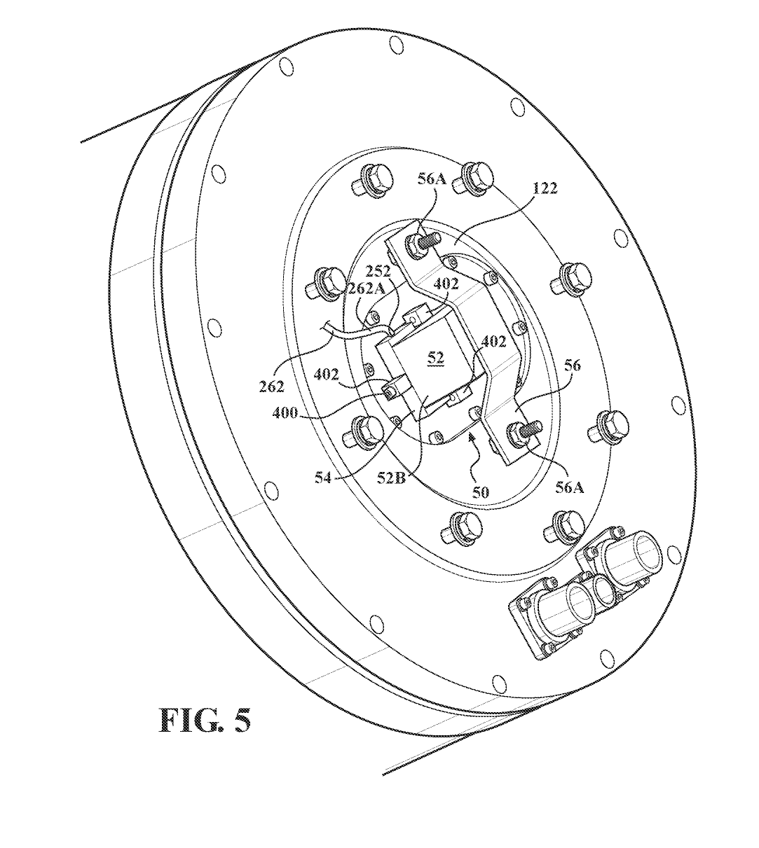

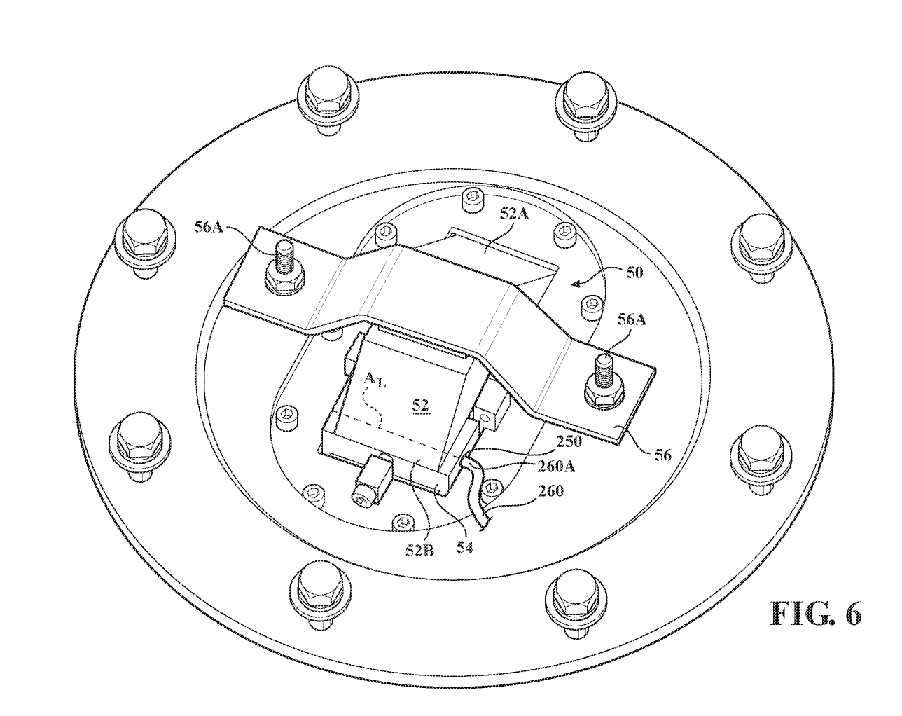

Inlet and outlet screen assemblies 270 and 272 are coupled externally to the second housing 14 via bolts 270A and 272A, see FIGS. 7 and 8. The inlet screen assembly 270 comprises an inlet screen 270B and a fitting 270C. An internal cavity 1270 is defined by a recess 270D in a main body 270E and covered by the inlet screen 270B. Passages 1272 and 1274 are also formed in the main body 270E, see FIG. 8. The screen 270B is held in position relative to the main body 270E by a backing plate 270F and first and second side plates 270G and 270H, see FIG. 8. Water flows through the inlet screen 270B, the internal cavity 1270, the first and second passages 1272 and 1274 and into the fitting 270C. The outlet screen assembly 272 comprises an outlet screen 272B and a fitting 272C. An internal cavity (not shown) is defined by a recess (not shown) in an outlet screen assembly main body (not shown) and covered by the outlet screen 272B. Passages (not shown) are also formed in the outlet screen assembly main body. The screen 272B is held in position relative to the main body by a backing plate 272F and first and second side plates 272G and 272H, see FIG. 7. Water flows through the fitting 272C, the second and first passages, the internal cavity, and out the outlet screen 272B. It is noted that the inlet and outlet screens 270B and 272B may be formed from a copper mesh to inhibit microorganism growth.

It is further noted that, while allowing small aquatic species to enter the sensing device 10 through the inlet screen assembly 270 may be desirable, i.e., if it is desired to sense such small aquatic species by the sensing apparatus 30, larger aquatic species are preferably not permitted to enter the sensing device 10 through the inlet screen assembly 270, as these larger aquatic species could clog or become lodged in the components of the sensing device 10. The large inlet screen area, which leads to the narrow passages 1272 and 1274, decreases the chance of the inlet screen 270B becoming completely blocked such that no flow may enter the sensing device 10. The large inlet screen area, which leads to the narrow passages 1272 and 1274, also provides a low flow rate at the inlet screen assembly 270. This may be beneficial as it may decrease the tendency for large particles to get caught on the inlet screen 270 due to the suction generated by a pump 322, discussed below. This may also be beneficial, as some motile aquatic species have an instinct to swim upstream, e.g., so as to keep themselves out of a predator's mouth. Hence, the low flow rate at the inlet screen assembly 270 may reduce the number of motile aquatic species that are startled by the acceleration of being drawn through the inlet screen 270B into the sensing device 10 by remaining below the acceleration threshold that would alert them to swim away from the inlet screen assembly 270. The inlet and outlet screen assemblies 270 and 272 are configured similarly so that the direction of the flow generated by the pump 322 can be reversed to back flush any particulates that have jammed or become lodged in the sensing device 10.

A third conduit 280, located external to the second housing internal chamber 14A, is coupled to and extends between the inlet screen assembly fitting 270C and a first inlet fitting 284 on the second housing 14. A fourth conduit 290, located internally within the second housing internal chamber 14A, is also coupled to the first inlet fitting 284 and extends to a valve 300 located within the second housing internal chamber 14A. A fifth conduit 310, located internally within the second housing internal chamber 14A, extends from the valve 300 to a first outlet fitting 312 coupled to the second housing 14. A sixth conduit 314, located external to the second and third housing internal chambers 14A and 16A, extends from the first outlet fitting 312 to the inlet fitting 160 coupled to the third housing 16. A seventh conduit 316, located external to the second and third housing internal chambers 14A and 16A, extends from the outlet fitting 162 coupled to the third housing 16 to a second inlet fitting 318 coupled to the second housing 14. An eighth conduit 320A, located internally within the second housing internal chamber 14A, extends from the second inlet fitting 318 to a flow meter 321. A ninth conduit 320B extends from the flow meter 321 to the pump 322, such as a conventional peristaltic pump. A tenth conduit 324, located internally within the second housing internal chamber 14A, extends from the pump 322 to the valve 300. An eleventh conduit 326, located internally within the second housing internal chamber 14A, extends from the valve 300 to a second outlet fitting 328 coupled to the second housing 14. A twelfth conduit 330 extends from the second outlet fitting 328 to the outlet screen assembly fitting 272C.

In the illustrated embodiment, portions of the fifth and tenth conduits 310 and 324 and substantially all of the first, second, third, fourth, sixth, seventh, eighth, ninth, eleventh and twelfth conduits 260, 262, 280, 290, 314, 316, 320A, 320B, 326 and 330 are formed from a polymeric material, such as silicone. A portion, e.g., about 12 inches, of each of the fifth and tenth conduits 310 and 324 may be formed from copper, which copper portions are believed to minimize microorganism growth in the conduits 260, 262, 280, 290, 310, 314, 316, 320A, 320B, 324, 326 and 330.

When the device 10 is operational to analyze water, the valve 300 is opened to allow water to pass through the valve 300 and the fourth and fifth conduits 290 and 310 so as to move toward the flow cell 54 and allow water moving away from the flow cell 54 to pass through the valve 300 and the tenth and eleventh conduits 324 and 326. When the device 10 is not operational, the valve 300 is closed to reduce the likelihood that organisms will enter and grow within the flow cell passage 54A. It is also noted that if a ultra-violet (UV) light source is provided in the first housing internal chamber 12A, it is normally activated only when the device 10 is not being used to analyze water passing through the flow cell passage 54A. The UV light source is positioned such that UV light passes through the flow cell passage 54A, whereby the UV light functions to prevent organisms from growing and/or kill organisms contained within the flow cell passage 54A.

Because the external optics and sample providing structure 50 is contained within the third housing internal chamber 16A and the internal chamber 16A may be filled with distilled water, risk that organisms may grow on the structure 50 is minimized.

With the valve 300 in its open state, the pump 322 is actuated to cause water to be pulled through the inlet screen assembly 270 and the third, fourth, fifth, sixth and first conduits 280, 290, 310, 314 and 260 into the flow cell passage 54A. The flow rate through the passage 54A may be from about 0.5 milliliters/minute to about 2.0 milliliters/minute. While passing through the passage 54A, the water is analyzed in the illustrated embodiment in the following manner.

A laser beam is generated by the laser source 44 forming part of the optical analysis and imaging apparatus 32. The laser beam passes through the one or more excitation filters 424, see FIG. 3, which excitation filters 424 may be used to remove unwanted wavelengths, such as all wavelengths other than, for example, 532 nanometers or 488 nanometers, from the laser beam. The laser beam then passes through the objective 401 and exits the first housing internal chamber 12A through the window 124A and passes into and through the flow cell 54, including the flow cell passage 54A. When a particle in the water flowing through the flow cell passage 54A encounters the laser beam, the particle scatters the laser beam, which scattered laser light continues to generally follow a path P defined by the second and first mirrored surfaces 52B and 52A on the prism 52, back through the window 124A so as to re-enter the first housing internal chamber 12A and moves toward the forward scatter sensor 34. The forward scatter sensor 34 detects the scattered laser light and sends a corresponding signal to the processor apparatus. The processor apparatus then causes the backlight 42 to turn on briefly to provide illumination for the optical analysis and imaging apparatus 32. The light emitted from the backlight 42 generally follows the path P, in a direction opposite to the scattered laser light, such that the light from the backlight 42 travels out of the first housing internal chamber 12A through the window 124A and into the prism 52, where it is reflected off the first and second mirrored surfaces 52A and 52B and passes through the flow cell 54, including the flow cell passage 54A. A portion of the light from the backlight 42 is blocked by particles in the water passing through the flow cell passage 54A. Light not blocked by particles in the water passing through the flow cell passage 54A re-enters the first housing internal chamber 12A through the window 124A and flows through the objective 401 to the partial mirror 426. The partial mirror 426 directs a portion of the light to the camera C, where the light is imaged by the camera C via a physical light imaging process. A remaining portion of the light passes through the partial mirror 426 to the one or more fluorescence emission filters 428 and on to the first and second photo multiplier tubes T₁ and T₂, see FIG. 3. This portion of the light may be ignored by the photo multiplier tubes T₁ and T₂.

The laser beam may also simultaneously cause the particles to fluoresce. Some of the light emitted by a particle fluorescing passes out from the flow cell passage 54A, re-enters through the window 124 and flows through the objective 401 to the partial mirror 426. The partial mirror 426 allows a portion of the light to pass therethrough to the one or more fluorescence emission filters 428, which fluorescence emission filters 428 may permit only certain wavelengths of light, e.g., 660 nanometers for chlorophyll analysis and 575+/−20 nanometers for phycoerythrin analysis, therethrough to pass to the first and second photo multiplier tubes T₁ and T₂. It is noted that a spacer structure 430, shown in FIG. 3, spaces the second photo multiplier tube T₂ a desired distance from the fluorescence emission filters 428. A second portion of the light emitted by the particle fluorescing is directed by the partial mirror 426 to the camera C. The camera C may ignore this portion of the light.

The processor apparatus, based on the imaging effected by the camera C and the first and second photo multiplier tubes T₁ and T₂, uses conventional techniques to characterize and quantify the microscopic particles suspended in the stream of water passing through the flow cell passage 54A.

It is noted that the flow cell passage 54A has a longitudinal axis A_{L}, see FIG. 6, substantially parallel with a fluid flow path through the passage 54A and a cross sectional area substantially transverse to the longitudinal axis A_{L} sized such that generally all fluid flowing through the passage 54A is analyzed by the sensing structure. That is, the flow cell passage cross sectional area is preferably sized to substantially match a field of view and depth of focus of the optical analysis and imaging apparatus 32.

After passing through the flow cell passage 54A, the water leaves the flow cell 54 via the second, seventh, eighth, ninth, tenth, eleventh and twelfth conduits 262, 316, 320A, 320B 324, 326 and 330 and then exits the device 10 via the outlet screen 272B.

The position of the flow cell 54 may be adjusted relative to the imaging apparatus 32 via three screws in the illustrated embodiment (only one screw 400 is illustrated in FIG. 5), which screws pass through threaded bores in projections 402, forming part of the support plate 126, see FIG. 5.

As noted above, the internal chamber 16A of the third housing 16 is preferably filled with a liquid, e.g., distilled water, which approximately matches the optical index of glass, i.e., the index of refraction of water is 1.333 and the index of refraction of the window 124A, if formed from borosilicate glass, is 1.515. The use of distilled water is preferable, since the liquid in the internal chamber 16A surrounds the window 124A, which, as noted above, is preferably formed from glass or polymeric material, and which is imaged by the sensing structure 30. By using a liquid that approximately matches the optical index of the window 124A, reflections encountered by the sensing structure 30 are believed to be reduced. Hence, the light throughput for imaging is improved and laser reflections are reduced, which are believed to improve the instrument fluorescence and scatter sensitivity. Specifically, Snell's law states that when light travels from a medium of index of refraction n1 to a medium of index of refraction of n2, the angle of transmission, θt, is related to the angle of incidence, θi, by the equation:

n1·sin θi=n2·sin θt

Further, Fresnel's formula states that when optical radiation travels from a medium of index of refraction n1 to a medium of index of refraction of n2, the light component perpendicular to the surface has a portion reflected in an amount given by the equation:

$$R = ( \frac{( n 1 \cdot cos θ i - n 2 \cdot cos θ t )}{n 1 \cdot cos θ i + n 2 \cdot cos θ t} )$$

Moreover, the transmitted portion of this same perpendicular component of light is given by the equation:

$$T = ( \frac{( 2 \cdot n 1 \cdot cos θ i )}{n 1 \cdot cos θ i + n 2 \cdot cos θ t} )$$

For the light component parallel to the plane of incidence, the light has a portion reflected in an amount given by the equation:

$$R = \frac{( ( \frac{1}{n 2} ) \cdot cos θ t - ( \frac{1}{n 1} ) \cdot cos θ i )}{( \frac{1}{n 2} ) \cdot cos θ t + ( \frac{1}{n 1} ) \cdot cos θ i}$$

For this same parallel component of light, the portion of transmitted from medium of index of refraction n1 to medium of index of refraction n2 is given by the equation:

$$T = \frac{( ( \frac{2}{n 2} ) \cdot cos θ i )}{( \frac{1}{n 2} ) \cdot cos θ t + ( \frac{1}{n 1} ) \cdot cos θ i}$$

As the indices of refraction in these equations approach each other, the reflection goes down and the transmission coefficients increase. When n1 and n2 are equal, Snell's law states that the angles θi and θt are equal. In that case, the reflections can be seen to go to zero and the transmissions go to unity for perfect transmission.

In other words, for imaging and measuring optics in the sensing structure 30, as the index of refraction of the fluid between the window 124A and the flow cell prism 52 gets closer to the index of refraction of the glass from which the window 124A is formed and the glass from which the prism 52 if formed, the laser light used to excite fluorescence in the sample, the scatter light from the sample, and the imaging light used to illuminate the sample for imaging do not reflect off of the glass interfaces. Rather, these lights travel in the direction they are intended to, resulting in more laser light getting to the sample, more scatter and fluorescence light getting to the appropriate detectors, and more imaging light getting to the sensing structure 30 for better images. It also means that there is less laser light back-reflected to the camera C and to the fluorescence measuring photo-multiplier tubes T₁ and T₂.

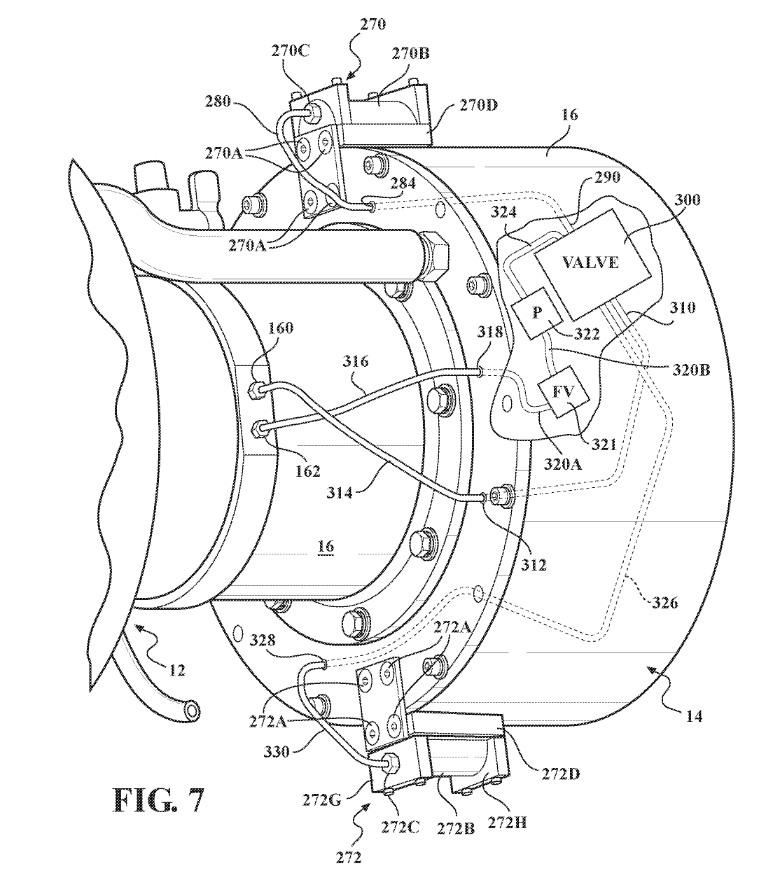

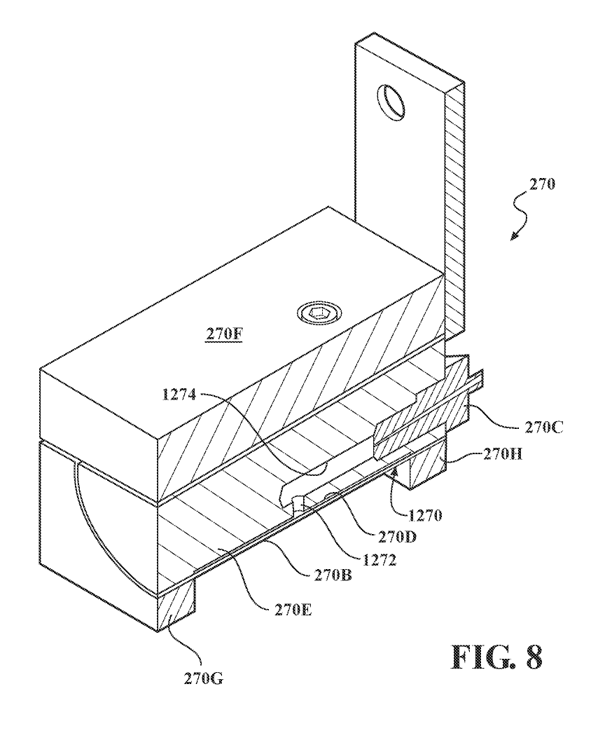

Referring now to FIGS. 9-13, a sensing structure 130 according to another aspect of the invention is shown, where elements similar to those described above with respect to FIGS. 1-8 include the same reference numbers. The sensing structure 130 comprises an optical analysis and imaging apparatus 32, a forward scatter sensor 34, an objective or lens 401, one or more excitation filters 424, a partial mirror 426, one or more fluorescence emission filters 428, and a spacer structure 430. The sensing structure 130 may also include a computer controlled electro-mechanical focus mechanism 400, such as, for example, an Extended Motorized MicroMini Stage model number MM-3M-EX-1.0, which is commercially available from National Aperture, Inc. Electronics such as a processor apparatus (not shown) is provided for controlling the operation of the sensing structure 130 and light-providing apparatus 40.

The focus mechanism 400 may be used to move the objective or lens 401 relative to the optical analysis and imaging apparatus 32 (which comprises a camera C and first and second photo-multiplier tubes T₁ and T₂), the forward scatter sensor 34, the excitation filters 424, the partial mirror 426, the fluorescence emission filters 428, and the spacer structure 430, to an optimal position relative to the flow cell passage 54A during operation of the sensing structure 130. The focus mechanism 400 can move the objective 401 toward or away from the flow cell 54 and the flow cell passage 54A to adjust the imaging quality of the camera C and/or to adjust the fluorescence measuring of the photo-multiplier tubes T₁ and T₂. Such movement of the objective 401 may be useful to compensate for temperature or mechanical variations in instrument dimensions, which variations may cause the camera C to go out of focus. The focus mechanism 400 can be controlled automatically by conventional focusing algorithms, such as, for example, by the processor apparatus sensing a decrease in focus of the camera C by monitoring data retrieved from the camera C. This data can be used by the processor apparatus to control actuation of the focus mechanism 400 to move the objective 401. Similar focusing algorithms are used in point and shoot cameras and video cameras and are commonly referred to as “contrast-detect auto focus.” It is also noted that the focus mechanism 400 could be controlled manually, e.g., by an operator located remotely from the sensing device 10.

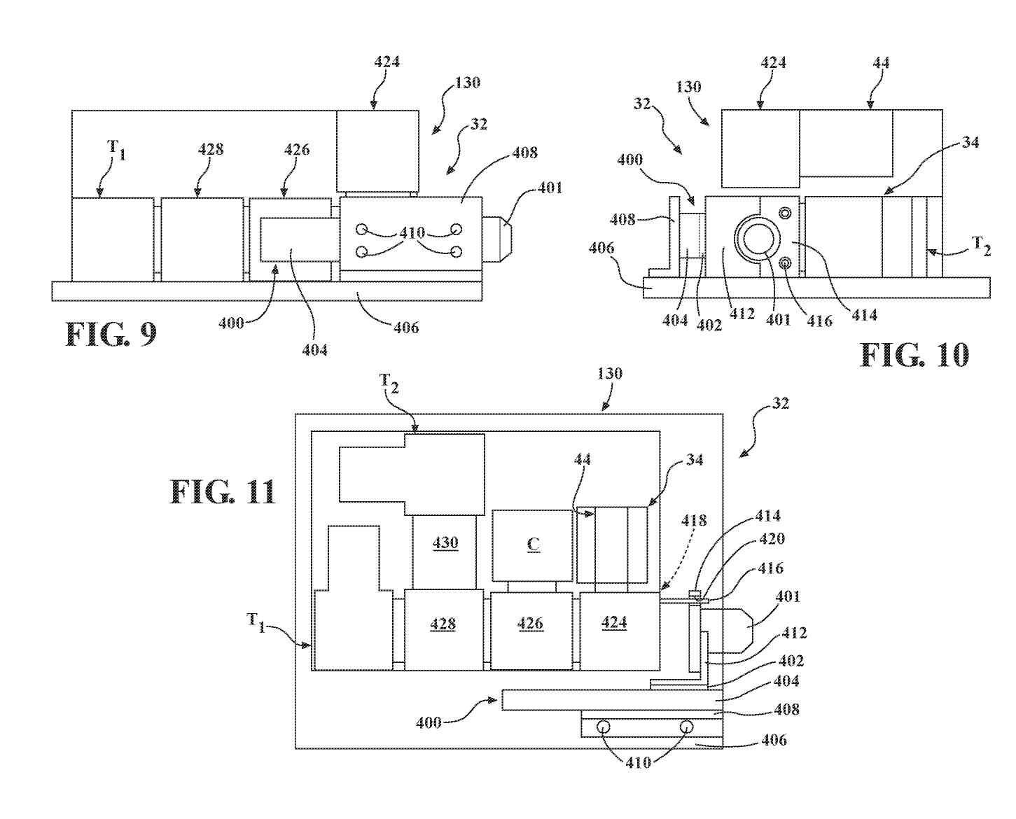

As shown in FIGS. 9-11, the focus mechanism 400 comprises a slider apparatus 402 and a motor apparatus 404. The motor apparatus 404 is coupled to a baseplate 406 via a bracket 408 and a plurality of mounting screws 410. The baseplate 406, in turn, is coupled to a floor of the first housing 12 (not shown in FIGS. 9-11). The motor apparatus 404 can be controlled automatically by focusing algorithms or manually by an operator as discussed above. The slider apparatus 402 is coupled to the objective 401 via a bracket 412 and an objective plate 414, which objective plate 414 is coupled to the bracket 412 and to the objective 401. The motor apparatus 404 comprises an encoder (not shown), an electric motor (not shown) and a lead screw (not shown) coupled to the motor and the slider apparatus 402. The motor apparatus 404, when actuated, turns the lead screw to effect movement of the slider apparatus 402 and, hence, the bracket 412 and the objective plate 414, to effect movement of the objective 401. Movement of the objective plate 414 is guided by rods 416 coupled to a support cube 418, which is located underneath the excitation filters 424 (see FIG. 11), and extending through corresponding openings 420 in the bracket 412. It is noted that the focus mechanism 400 may derive all power from a USB bus connection to the processor apparatus that controls the operation of the sensing structure 30. It is also noted that the focus mechanism 400 may communicate with the processor apparatus via the USB bus connection.

During operation of the sensing structure 130, a laser source 44 emits a laser beam as discussed above with reference to FIGS. 1-8. The laser beam may pass through the one or more excitation filters 424, see FIGS. 9-12, which excitation filters 424 are used to remove unwanted wavelengths, such as all wavelengths other than, for example, 532 nanometers or 488 nanometers, from the laser beam.

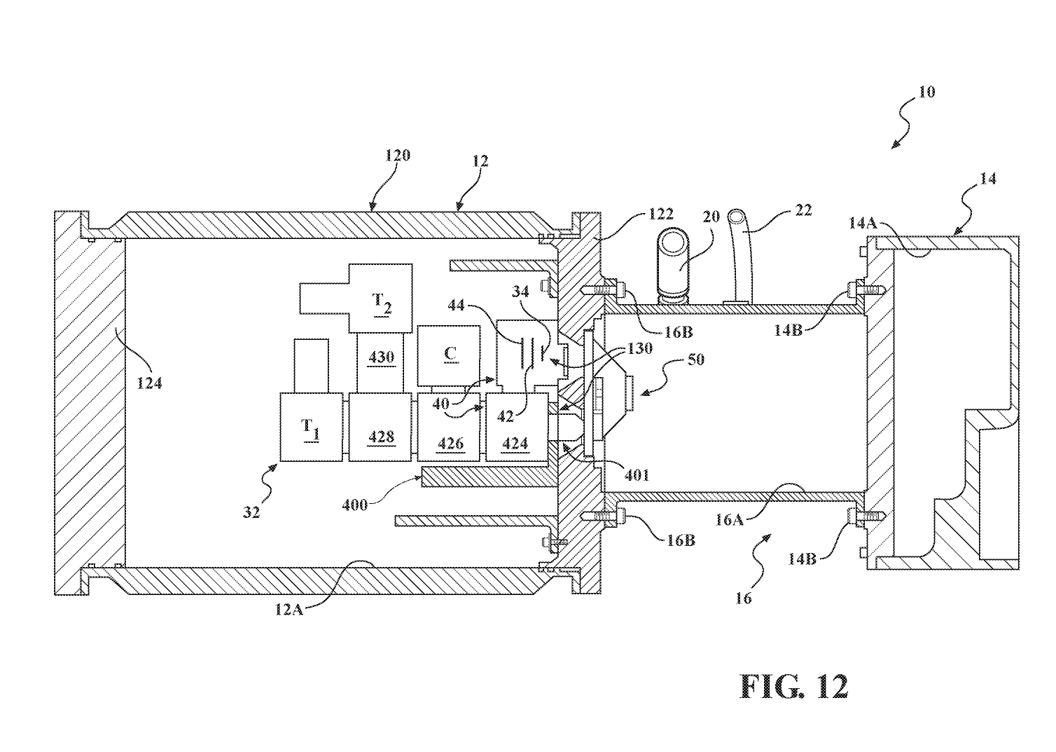

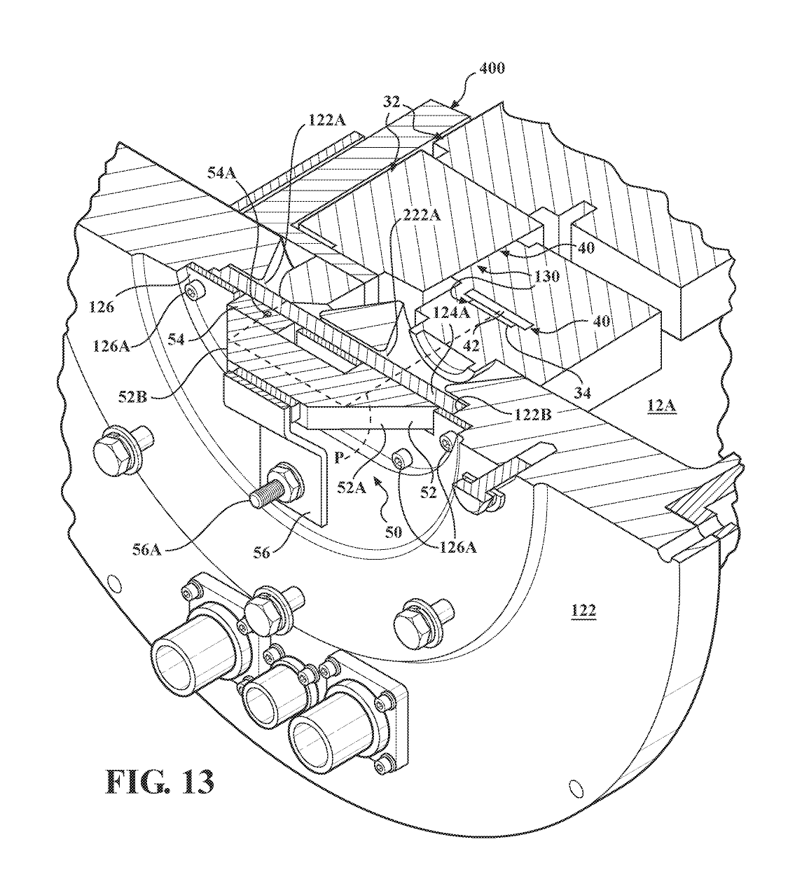

Referring to FIGS. 12 and 13, the laser beam then passes through the objective 401 and exits the first housing internal chamber 12A through the window 124A and passes into and through the flow cell 54. When a particle in the water flowing through the flow cell passage 54A encounters the laser beam, the particle scatters the laser beam and the light from the laser beam re-enters the first housing internal chamber 12A through the window 124A. The light is detected by the scatter sensor 34, which sends a corresponding signal to the processor apparatus, wherein the processor apparatus causes a backlight 42 to turn on briefly to provide illumination for the optical analysis and imaging apparatus 32.

A portion of the light from the backlight 42 is blocked by particles in the water passing through the flow cell passage 54A, and light not blocked by particles in the water passing through the flow cell passage 54A re-enters the first housing internal chamber 12A through the window 124A and flows through the objective 401 to the partial mirror 426. The partial mirror 426 allows a portion of the light to pass to the camera C, where the light is imaged by the camera C via a physical light imaging process.

The laser beam may also simultaneously cause the particles to fluoresce, wherein some of the light emitted by a particle fluorescing, re-enters through the window 124 and flows through the objective 401 to the partial mirror 426. The partial mirror 426 allows a portion of the light to pass therethrough, e.g., 660 nanometers for chlorophyll analysis and 575+/−20 nanometers for phycoerythrin analysis, to the one or more fluorescence emission filters 428, which fluorescence emission filters 428 may permit only certain desirable wavelengths of light therethrough to pass to the first and second photo multiplier tubes T₁ and T₂. As discussed above, a spacer structure 430, shown in FIG. 11, spaces the second photo multiplier tube T₂ a desired distance from the fluorescence emission filters 428.

The processor apparatus, based on the imaging effected by the camera C and the first and second photo multiplier tubes T₁ and T₂, uses conventional techniques to characterize and quantify the microscopic particles suspended in the stream of water passing through the flow cell passage 54A.

While a particular embodiment of the present invention has been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fluid submersible sensing device comprising:
a fluid-tight housing defining an internal chamber and including window structure;
sensing structure provided in said internal chamber;
light providing apparatus in said internal chamber emitting light capable of passing through said window structure so as to exit said housing; and
an external structure coupled to said housing and located outside of said housing internal chamber comprising a passage through which a fluid flows and one or more optical elements for causing the light from the housing to pass through said passage and re-enter said housing toward said sensing structure.

2. The device as set out in claim 1, wherein said light providing apparatus comprises a laser light source.

3. The device as set out in claim 2, wherein said light providing apparatus further comprises a backlight source.

4. The device as set out in claim 1, wherein said sensing structure comprises an optical analysis and imaging apparatus.

5. The device as set out in claim 1, wherein said external structure comprises:
a primary element comprising said one or more optical elements; and
a flow cell defining said passage.

6. The device as set out in claim 5, wherein said primary element comprises a prism including said one or more optical elements defined by first and second mirrored surfaces on said prism to reflect the light along a desired path such that the light passes through said flow cell including said passage and then re-enters said housing.

7. The device as set out in claim 5, wherein said flow cell comprises a clear body separate from said primary element and has said passage extending through it.

8. The device as set out in claim 7, wherein said passage has a longitudinal axis substantially parallel with a fluid flow path through said passage and a cross sectional area substantially transverse to said longitudinal axis sized such that generally all fluid flowing through said passage is analyzed by said sensing structure.

9. The device as set out in claim 7, wherein said passage cross sectional area substantially matches a field of view and depth of focus of an optical analysis and imaging apparatus defining said sensing structure.

10. A fluid submersible sensing device comprising:
a fluid-tight housing defining an internal chamber and including window structure;
sensing structure provided in said internal chamber;
light providing apparatus in said internal chamber emitting light capable of passing through said window structure so as to exit said housing; and
a sample-providing structure coupled to said housing and located outside of said housing internal chamber comprising a passage through which a fluid flows, said passage having a longitudinal axis substantially parallel with a flow path through said passage and a cross sectional area substantially transverse to said longitudinal axis, wherein the light from the housing exits said housing, passes through said sample-providing structure including said passage and re-enters said housing toward said sensing structure, and said passage cross sectional area is sized such that generally all fluid flowing through said passage is analyzed by said sensing structure.

11. The device as set out in claim 10, wherein said light providing apparatus comprises a laser light source.

12. The device as set out in claim 11, wherein said light providing apparatus further comprises a backlight source.

13. The device as set out in claim 10, wherein said sensing structure comprises an optical analysis and imaging apparatus.

14. The device as set out in claim 10, wherein said sample-providing structure comprises:
a primary element comprising at least one optical element; and
a flow cell defining said passage.

15. The device as set out in claim 14, wherein said primary element comprises first and second mirrored surfaces to reflect the light along a desired path such that the light passes through said flow cell and then re-enters said housing.

16. The device as set out in claim 15, wherein said flow cell comprises a clear body separate from said primary element and has said passage extending through it.

17. The device as set out in claim 10, wherein said passage cross sectional area substantially matches a field of view and depth of focus of an optical analysis and imaging apparatus defining said sensing structure.

18. The device as set out in claim 10, wherein said window structure is formed from a single piece of material.

19. The device as set out in claim 14, further comprising a pressure-compensated second housing comprising electronic components and a pressure-compensated third housing containing said sample providing structure, said second housing separable from said third housing such that said flow cell in said third housing can be serviced without opening said second housing.

20. The device as set out in claim 19, wherein said second housing contains a dielectric fluid.

21. The device as set out in claim 10, wherein said third housing contains distilled water.

22. The device as set out in claim 10, further comprising a focusing mechanism in said internal chamber of said fluid-tight housing for moving a part of said sensing structure with respect to said passage of said sample providing structure.
